(19) United States
(12) Patent Application Publication
(10) Pub. No.: US 2002/0034647 A1
(43) Pub. Date: Mar. 21, 2002

(54) Methof for forming dielectric of low dielectric constant on hydrophilic dielectric and the structure

(76) Inventors: Anseime Chen, Hsinchu (TW); Cheng-Yuan Tsai, Yunlin Hsien (TW); I-Hsiung Huang, Kaohsiung (TW)

Correspondence Address: J.C. Patents, Inc., 4 Venture, Suite 250, Irvine, CA, 92614, US

(21) Appl. No.: 09/835,280

(22) Filed: Apr. 13, 2001

(30) Foreign Application Priority Data
Sep. 21, 2000 (TW) 89119435

(51) Int. Cl. B32B 9/04

(52) U.S. Cl. 428/447

(57) ABSTRACT

A method is to form a dielectric layer with low dielectric constant on a hydrophilic dielectric layer. The method includes providing a substrate, which has a first dielectric layer on top. A hydrophilic second dielectric layer is formed on the first dielectric layer. A HMDS adhesion promoter layer is formed on the second dielectric layer. A dielectric layer with low dielectric constant, such as organic spin-on dielectric material or a hydrophilic dielectric material, is formed on the HMDS adhesion promoter layer. In the foregoing, the HMDS adhesion promoter layer has thickness of about 10-20 angstroms.

### CROSS-REFERENCE TO RELATED APPLICATION

This application claims the priority benefit of Taiwan application serial no. 89119435, filed Sep. 21, 2000.

### BACKGROUND OF THE INVENTION

1. Field of Invention

The present invention relates to semiconductor fabrication. More particularly, the present invention relates to a method for forming a dielectric layer with low dielectric constant on a hydrophilic dielectric layer, and a structure formed by the method.

2. Description of Related Art

As dimension of the integrated-circuit device is continuously reduced, the fabricating technology now can reach 0.18 microns or less, such as a copper interconnect fabrication. In this fabrication generation, the dielectric material, used in the interconnect structure, usually takes low dielectric constant. The purpose is to reduce the parasitic capacitance induced by the dielectric layer of the interconnect structure. The parasitic capacitance may cause a too large resistance-capacitance (RC) delay time, resulting in a poor operation performance of the device. Particularly, when the fabrication technology is reduced to 0.13 microns, the dielectric must be formed by low dielectric constant to replace the usual dielectric material with high dielectric constant, such as silicon oxide. The low dielectric constant is defined as those materials with dielectric constant less than 4, such as organic spin-on dielectric material.

Even though the organic spin-on dielectric material has low dielectric constant, its hardness is also low. Usually, a thin hard dielectric layer, such as silicon oxide, silicon nitride, or silicon oxynitride, formed on top of the organic spin-on dielectric layer, so as to achieve the required mechanical strength. Then, a next-level interconnect structure is formed in the dielectric layer. However, the hard dielectric layer has strong hydrophilic surface that is also called high polar surface. On the contrary, the organic spin-on dielectric material has hydrophobic surface that is also called non-polar surface. This difference of hydrophilic and hydrophobic causes that an organic spin-on dielectric layer cannot be formed on the thin hard dielectric layer. A conventional method is proposed to solve this issue by forming an adhesion promoter layer on the hard dielectric layer, so as to change the surface polar degree of the hard dielectric layer. As a result, the hydrophilic organic spin-on dielectric can be coated on the hard dielectric. However, if the adhesion promoter layer is too thin, the organic spin-on dielectric material cannot be uniformly coated over the hard dielectric layer, causing a potential problem of the device. The thickness uniformity of the dielectric layer plays an essential role to determine the quality of the device. But, if the adhesion promoter layer is too thick, it causes an increase of the total averaged dielectric constant. This also results in a large RC delay time.

Conventionally, forming an organic spin-on dielectric layer on a previous dielectric layer is shown in FIG. 1. Referring to FIG. 1, a first level dielectric layer 102 is formed over a substrate 100. In the dielectric layer 102, a portion of interconnect structure (not shown) may have been formed. For the copper fabrication process with highly integrated level, the dielectric layer 102 typically includes material with low dielectric constant. A hard dielectric later 104 is formed on the dielectric layer 102. The hard dielectric layer 104 usually includes material with high dielectric constant that is the dielectric constant greater than 4.

In the foregoing, in order to enhance the adhesion capability for the second level dielectric layer, an adhesion promoter layer 106 is formed on the hard dielectric layer 104 for changing the hydrophilic surface of the hard dielectric layer 104, and becoming a hydrophobic surface. This allows a dielectric layer 108 with low dielectric constant is coated on the adhesion promoter layer 106.

The conventional adhesion promoter layer 106 is made of vinyl silane. Its thickness is about 200 angstroms. The reaction mechanism between vinyl silane and the hard dielectric layer 104 is shown in FIG. 2. In FIG. 2, there are many O—H functional bounds on a surface 110 of the hydrophilic dielectric layer, that is the hard dielectric layer 104, such as silicon oxide. If an organic spin-on dielectric layer is desired to be coated on the hard dielectric layer 104, typically it takes vinyl silane as the adhesion promoter layer 108. The molecular form 112 of vinyl silane is shown in FIG. 2. The vinyl silane also gives two O—H bounds.

When vinyl silane reacts with the surface of the dielectric layer, the two O—H bounds react with those O—H bounds on the hard dielectric later. The vinyl silane then is formed thereon and also produces two oxygen bounds. Even though the vinyl silane material can change the polar surface of the hard dielectric layer, it still cannot effectively transform all the O—H functional bounds on the hydrophilic surface. Moreover, the vinyl silane itself also leaves the oxygen functional bounds. Further still, vinyl silane stays in a liquid phase so that vinyl silane still cannot have a uniform surface.

Thus, the adhesion promoter of vinyl silane still has its drawbacks. Usually, its needs about 200 angstroms to effectively change the hydrophilic surface into the hydrophobic surface and also have a uniform surface. In this thickness, the total dielectric constant increases, resulting in the increases of RC delay time. How to reduce the thickness of the adhesion promoter layer is an issue to be solved.

### SUMMARY OF THE INVENTION

The invention uses HMDS [((CH₃)₃Si)₂NH] as the material of the adhesion promoter layer, so that the thickness can be effectively reduced by at least factor of ten, that is, about 10-20 angstroms.

The invention uses HMDS [((CH₃)₃Si)₂NH] as the material of the adhesion promoter layer, where HMDS under pressure is a vapor phase even though it original is a liquid phase. The vapor phase can effectively improve the surface uniformity.

As embodied and broadly described herein, the invention provides a method for forming a dielectric layer with low dielectric constant on a hydrophilic dielectric layer. The method includes providing a substrate, which has a first dielectric layer on top. A hydrophilic second dielectric layer is formed on the first dielectric layer. A HMDS adhesion promoter layer is formed on the second dielectric layer. A dielectric layer with low dielectric constant, such as organic spin-on dielectric material or a hydrophilic dielectric material, is formed on the HMDS adhesion promoter layer.

In the foregoing, the HMDS adhesion promoter layer has thickness of about 10-20 angstroms. Since the HMDS material is a vapor phase under pressure in deposition process, the thickness of 10-20 angstroms has been sufficient to have uniform surface. The HMDS can also effectively convert the hydrophilic functional bounds, such as O—H functional bounds, on the second dielectric layer into a hydrophobic surface.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional drawing, schematically illustrating a conventional method to form a dielectric layer with low dielectric constant on a hydrophilic dielectric layer; and

FIG. 2 is a drawing, schematically illustrating the reaction mechanism of vinyl silane formed on a hydrophilic dielectric surface; and

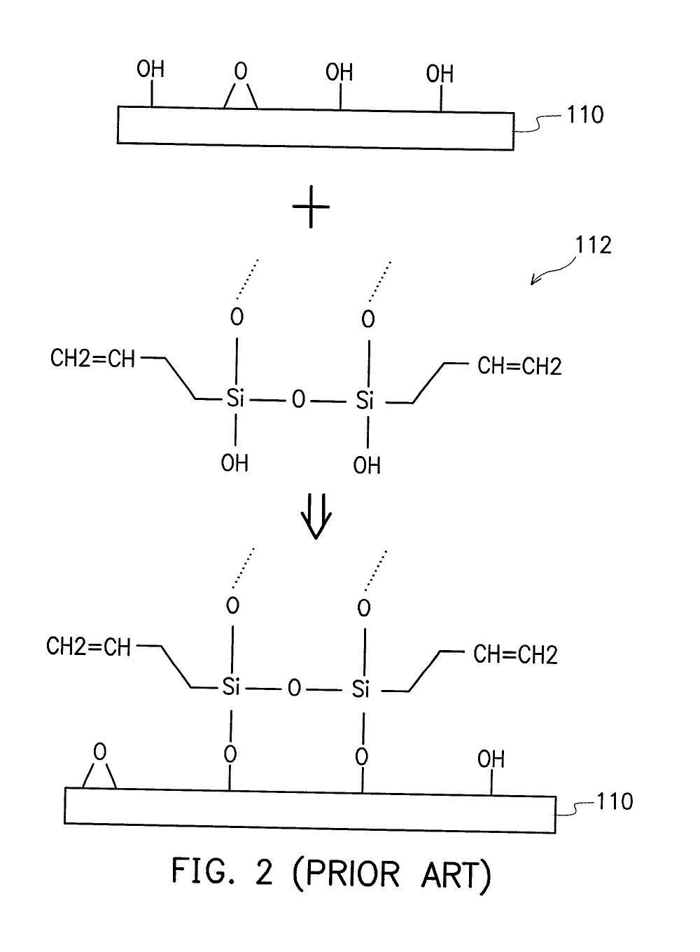

FIG. 3 is a drawing, schematically illustrating the reaction mechanism of HMDS formed on a hydrophilic dielectric surface, according to one preferred embodiment of this invention.

### DESCRIPTION OF THE PREFERRED EMBODIMENTS

The invention particularly uses hexamethyldisilazane (HMDS) [((CH₃)₃Si)₂NH] as the dielectric material, to serve as an adhesion promoter between hydrophilic dielectric and hydrophobic dielectric. The reaction mechanism of HMDS can more effectively change the hydrophilic surface into hydrophobic surface. This is helpful for the subsequent deposition of hydrophobic dielectric layer with low dielectric constant. Moreover, since the HMDS material is a vapor phase under an pressurizing environment, it is also helpful for deposition with an uniform thickness. Since the properties of the HMDS material, the thickness of the adhesion promoter layer is not necessary to be large. Preferably, a range of about 10 angstroms to about 20 angstroms is sufficient. The indicates that the thickness can be effectively reduced.

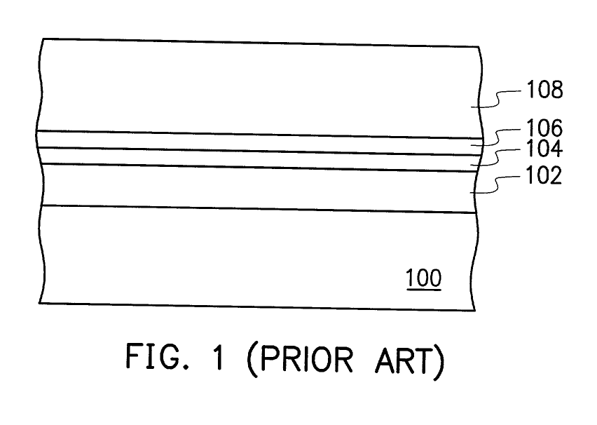

An example is provided as an example for descriptions in the following. As shown in FIG. 1, in order to form the intended via opening, contact opening, or interconnect structure in the dielectric layer 102 and have the sufficient mechanical strength, a thinner hard material 104 is usually formed on the previous dielectric layer 102. The hard dielectric layer usually includes, for example, silicon oxide, silicon nitride, silicon oxynitride. These hard dielectric materials have higher dielectric constant and are hydrophilic. In order to reduce the parasitic capacitance from the dielectric layer, the dielectric layer 108 usually takes the organic spin-on dielectric material, which has low dielectric constant. Since the hard dielectric material 104 is hydrophilic but the dielectric layer 108 is hydrophobic, these two dielectric layers need an adhesion promoter layer 106 between them to have the sufficient adhesive strength. The adhesion promoter layer conventionally is made of vinyl silane. It is still has some drawbacks for using vinyl silane. The invention discovers that HMDS with its properties can be uses as the adhesion promoter layer. In this manner, the adhesion ability is effectively enhanced. In addition, the thickness can also be effectively reduced.

When HMDS [((CH₃)₃Si)₂NH] reacts with water, the reaction mechanism is following:

(CH₃)₃—Si—NH—Si—(CH₃)₃+H₂O→2(CH₃)₃SiOH+NH₃.

After reaction, the product of Trimethylsianol (CH₃)₃SiOH has O—H functional bound, which is expected to be coupled with the hydrophilic dielectric. As a result, CH₃ of (CH₃)₃SiOH would cause the hydrophobic property. According to the same reaction mechanism, HMDS can react with the O—H functional bounds on the hydrophilic dielectric layer, so that the hydrophilic surface of the hard dielectric can be changed into a hydrophobic surface.

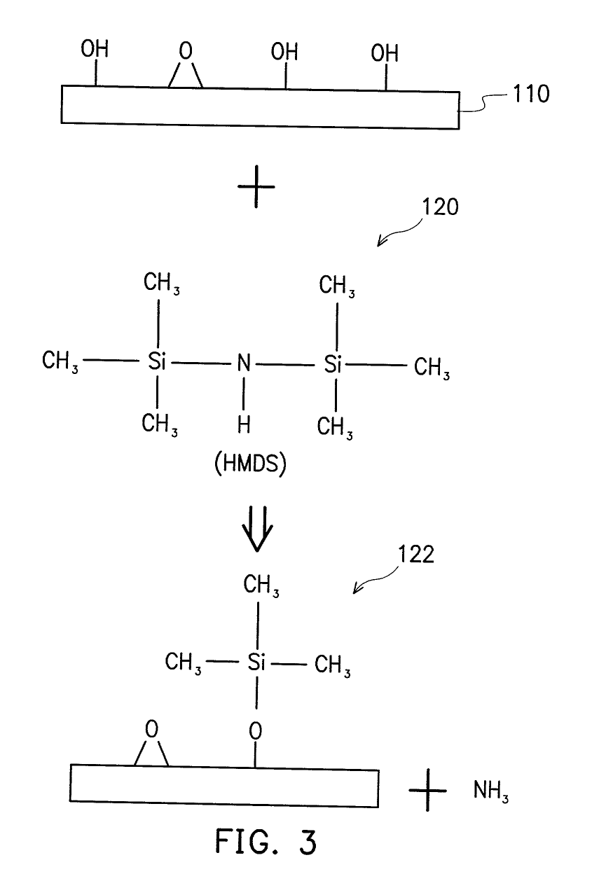

FIG. 3 is a drawing, schematically illustrating the reaction mechanism of HMDS formed on a hydrophilic dielectric surface, according to one preferred embodiment of this invention. In FIG. 3, the surface of the hydrophilic dielectric 110 has many O—H functional bounds. The molecular structure of HMDS is shown by molecule 120. The HMDS 120 material reacts with the hydrophilic dielectric 110, and the products 122 becomes hydrophobic. The N—H bounds of HMDS react with O—H bounds on the surface of the dielectric layer 110, and produces NH₃. The silicon atom is bound with three CH₃, which form the hydrophobic property. Since each (CH₃)₃SiOH can independently react with the O—H functional bound, the O—H functional bounds on the surface of the dielectric layer are effectively transformed. As a result, HMDS has effectively transform the dielectric layer 110 to be hydrophobic.

Moreover, HMDS also has another features that the liquid phase HMDS can be transformed into micro particles under a pressuring condition. The micro particles form a vapor-like phase. The vapor phase can greatly improve the depositing ability, so as to have a better uniform surface. The uniform surface is an essential role to assure the performance of devices.

Due to the properties of HMDS, the thickness is not necessary to be thick. The range of thickness, preferably, is about between 10 angstroms and 20 microns. Comparing the invention with the conventional adhesion promoter layer, which is about 200 Angstroms. This indicates that thickness of the adhesion promoter layer can be reduced by at least 10 or less.

In the foregoing, the invention using HMDS as an etching promoter has several features as follow:

1. The invention uses HMDS as the etching promoter, whereby the hydrophilic surface is effectively converted into hydrophobic surface. This adhesion ability of organic spin-on material to be formed on the hydrophilic surface.

2. The HMDS material of the invention can be transformed into vapor phase, which allows a better deposition to have a uniform surface.

3. Due to properties of the HMDS material of the invention, the thickness of the HMDS layer, whereby the total dielectric constant can be effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for forming dielectric material with low dielectric constant on a hydrophilic dielectric material, the method comprising:
providing a substrate, having a first dielectric layer;
forming a hydrophilic second dielectric layer on the first dielectric layer;
forming a hexamethyldisilazane (HMDS) adhesion promoter layer on the second dielectric layer; and
forming a dielectric layer of low dielectric constant on the HMDS adhesion promoter layer.

2. The method according to claim 1, wherein the dielectric layer of low dielectric constant comprises an organic spin-on dielectric material.

3. The method according to claim 1, wherein the dielectric layer of low dielectric constant comprises a hydrophobic dielectric material.

4. The method according to claim 1, wherein the hydrophilic second dielectric layer comprises silicon oxide.

5. The method according to claim 1, wherein the hydrophilic second dielectric layer comprises silicon nitride.

6. The method according to claim 1, wherein the hydrophilic second dielectric layer comprises silicon oxynitride.

7. The method according to claim 1, wherein the first dielectric layer comprises a material with low dielectric constant.

8. The method according to claim 1, wherein the HMDS adhesion promoter layer comprises a thickness of about between 10 angstroms and 20 angstroms.

9. An interconnect dielectric structure, comprising:
a substrate, having a first dielectric layer thereon;
a hydrophilic second dielectric layer, formed on the first dielectric layer;
a hexamethyldisilazane (HMDS) adhesion promoter layer, formed on the second dielectric layer; and
a dielectric layer of low dielectric constant, formed on the HMDS adhesion promoter layer.

10. The interconnect dielectric structure according to claim 9, wherein the dielectric layer of low dielectric constant comprises an organic spin-on dielectric material.

11. The interconnect dielectric structure according to claim 9, wherein the dielectric layer of low dielectric constant comprises a hydrophobic dielectric material.

12. The interconnect dielectric structure according to claim 9, wherein the hydrophilic second dielectric layer comprises silicon oxide.

13. The interconnect dielectric structure according to claim 9, wherein the hydrophilic second dielectric layer comprises silicon nitride.

14. The interconnect dielectric structure according to claim 9, wherein the hydrophilic second dielectric layer comprises silicon oxynitride.

15. The interconnect dielectric structure according to claim 9, wherein the first dielectric layer comprises a material with low dielectric constant.

16. The interconnect dielectric structure according to claim 9, wherein the HMDS adhesion promoter layer comprises a thickness of about between 10 angstroms and 20 angstroms.
